(19) United States
(12) Patent Application Publication
(10) Pub. No.: US 2021/0007935 A1
(43) Pub. Date: Jan. 14, 2021

(54) LIQUID MEDICAMENT DISPENSER

(71) Applicant: Maqbool Ahmed Zafar, Rancho Cucamonga, CA (US)

(72) Inventor: Maqbool Ahmed Zafar, Rancho Cucamonga, CA (US)

(21) Appl. No.: 16/946,550

(22) Filed: Jun. 26, 2020

Related U.S. Application Data
(60) Provisional application No. 62/872,479, filed on Jul. 10, 2019.

(51) Int. Cl. A61J 7/00

(52) U.S. Cl. CPC A61J 7/0053

(57) ABSTRACT

A liquid medicament dispenser having a tubular barrel extending from a plunger end to a cap end having a cap opening and without a washer. The present invention includes a plunger dimensioned and adapted to hermetically engage the inner circumference of the tubular barrel so that as it moves between a fully compacted condition and a partially compacted condition pressure develops therein, thereby urging a liquid medicament in or out through the cap end.

### CROSS-REFERENCE TO RELATED APPLICATION

This application claims the benefit of priority of U.S. provisional application No. 62/872,479, filed 10 Jul. 2019, the contents of which are herein incorporated by reference.

### BACKGROUND OF THE INVENTION

The present invention relates to medicinal applicators and, more particularly, a liquid medicament dispenser.

Current oral syringes consist of a barrel, plunger and silicone washer to function as a liquid medicament dispenser. Silicone washers, however, can get dirty and accumulate unhealthy debris and pathogens.

As can be seen, there is a need for a washer-less liquid medicament dispenser comprising an only two-piece assembly: barrel and plunger, requiring less time and cost to assemble, maintain, clean and operate as a functioning oral syringe.

### SUMMARY OF THE INVENTION

In one aspect of the present invention, liquid medicament dispenser without a washer includes the following: a tubular barrel extending from a plunger end to a cap end having a cap opening; and a plunger dimensioned to hermetically engage an inner circumference of the tubular barrel so that as the plunger moves between a compacted condition and a partially compacted condition pressure develops therein, thereby urging a flow out through the tubular barrel.

In another aspect of the present invention, liquid medicament dispenser without a washer includes the following: a tubular barrel extending from a plunger end to a cap end having a cap opening; a plunger dimensioned to hermetically engage an inner circumference of the tubular barrel so that as the plunger moves between a compacted condition and a partially compacted condition pressure develops therein, thereby urging a flow out through the tubular barrel; a cap dimensioned to engage the cap end in a sealed configuration, preventing said flow; and the cap being movable between the sealed configuration and an unsealed configuration; and the cap end is asymmetrically disposed along the cap end, wherein the tubular barrel defines a volumetric capacity ranging between one and ten milliliters.

These and other features, aspects and advantages of the present invention will become better understood with reference to the following drawings, description and claims.

### BRIEF DESCRIPTION OF THE DRAWINGS

FIG. 1 is a perspective view of a first embodiment of the present invention;

FIG. 2 is an exploded perspective view of the first embodiment of the present invention;

FIG. 3 is a longitudinal cross-sectional view of the first embodiment of the present invention, demonstrating a fully compacted condition;

FIG. 4 is a longitudinal cross-sectional view of the first embodiment of the present invention, demonstrating a partially compacted condition;

FIG. 5 is a perspective view of a second embodiment of the present invention;

FIG. 6 is an exploded perspective view of the second embodiment of the present invention;

FIG. 7 is a longitudinal cross-sectional view of the second embodiment of the present invention, demonstrating a fully compacted condition;

FIG. 8 is a longitudinal cross-sectional view of the second embodiment of the present invention, demonstrating a partially compacted condition;

FIG. 9 is a perspective view of a third embodiment of the present invention;

FIG. 10 is an exploded perspective view of the third embodiment of the present invention;

FIG. 11 is a longitudinal cross-sectional view of the third embodiment of the present invention, demonstrating a fully compacted condition;

FIG. 12 is a longitudinal cross-sectional view of the third embodiment of the present invention, demonstrating a partially compacted condition;

FIG. 13 is a perspective view of a fourth embodiment of the present invention;

FIG. 14 is an exploded perspective view of the fourth embodiment of the present invention;

FIG. 15 is a longitudinal cross-sectional view of the fourth embodiment of the present invention, demonstrating a fully compacted condition;

FIG. 16 is a longitudinal cross-sectional view of the fourth embodiment of the present invention, demonstrating a partially compacted condition;

FIG. 17 is a perspective view of a fifth embodiment of the present invention;

FIG. 18 is an exploded perspective view of the fifth embodiment of the present invention;

FIG. 19 is a longitudinal cross-sectional view of the fifth embodiment of the present invention, demonstrating a fully compacted condition; and

FIG. 20 is a longitudinal cross-sectional view of the fifth embodiment of the present invention, demonstrating a partially compacted condition.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a liquid medicament dispenser having a tubular barrel extending from a plunger end to a cap end having a cap opening and without a washer. The present invention includes a plunger dimensioned and adapted to hermetically engage the inner circumference of the tubular barrel so that as it moves between a fully compacted condition and a partially compacted condition pressure develops therein, thereby urging a liquid medicament in or out through the cap end.

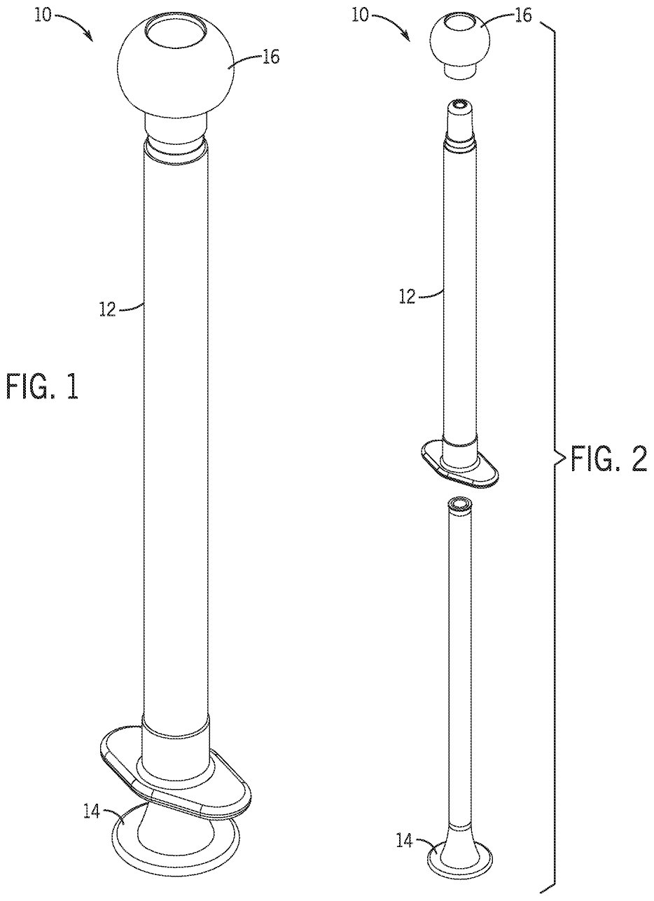

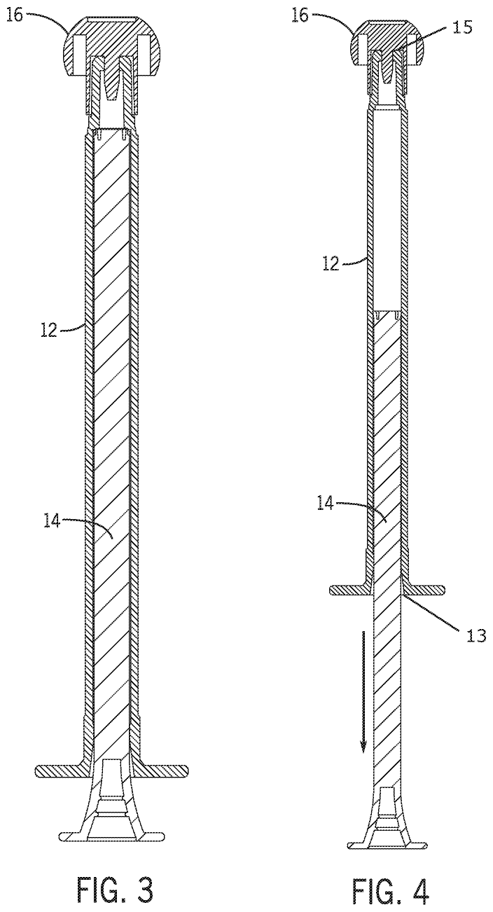

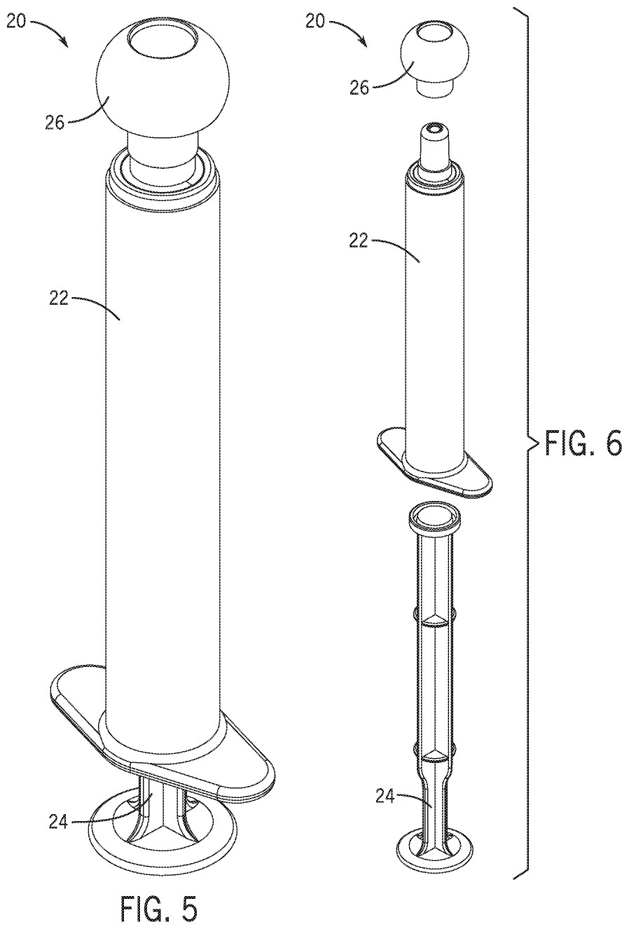

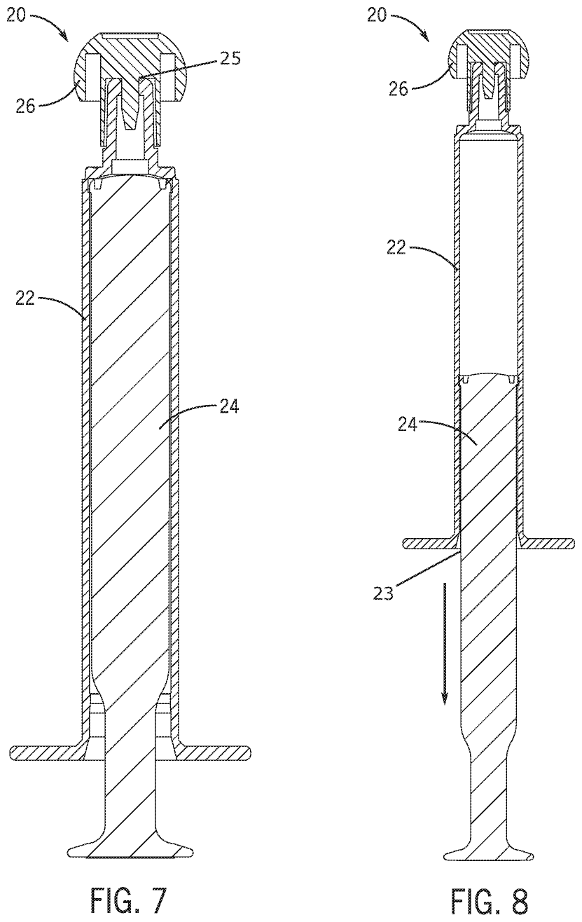

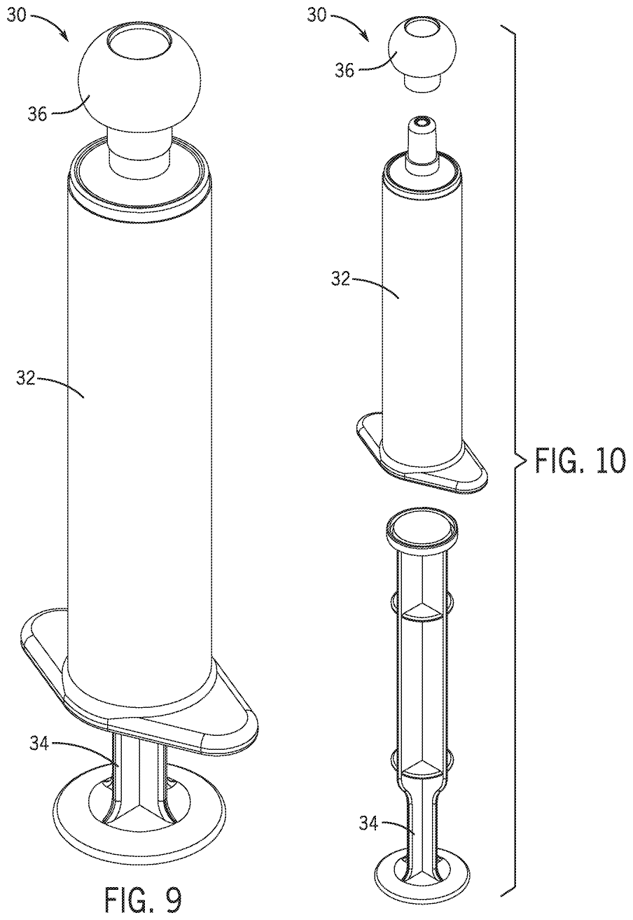

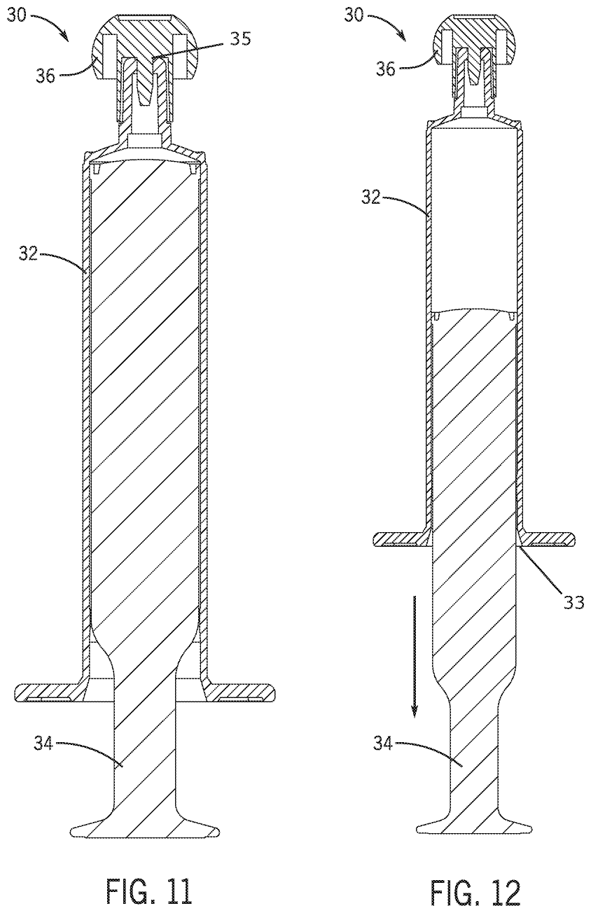

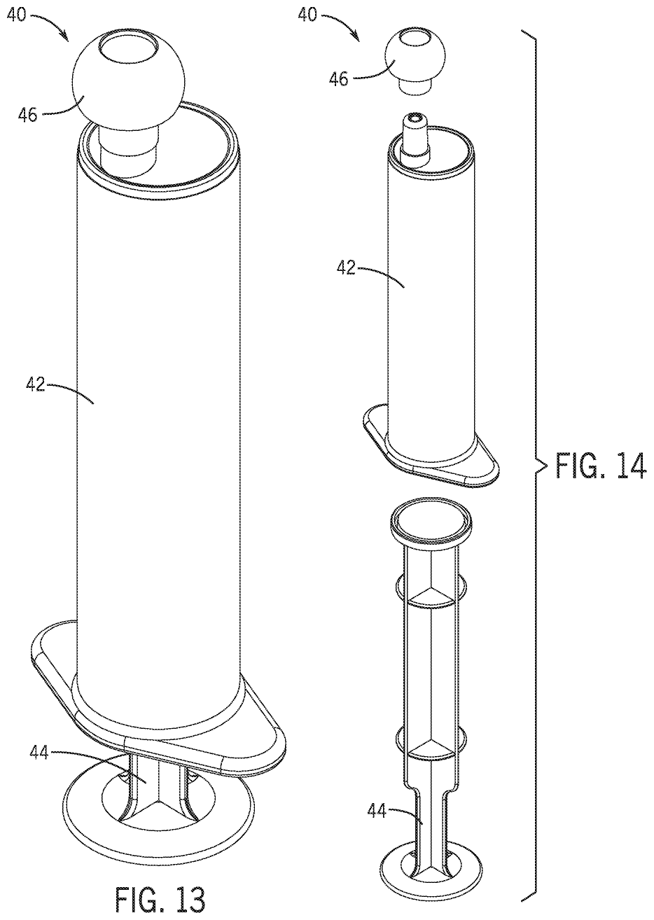

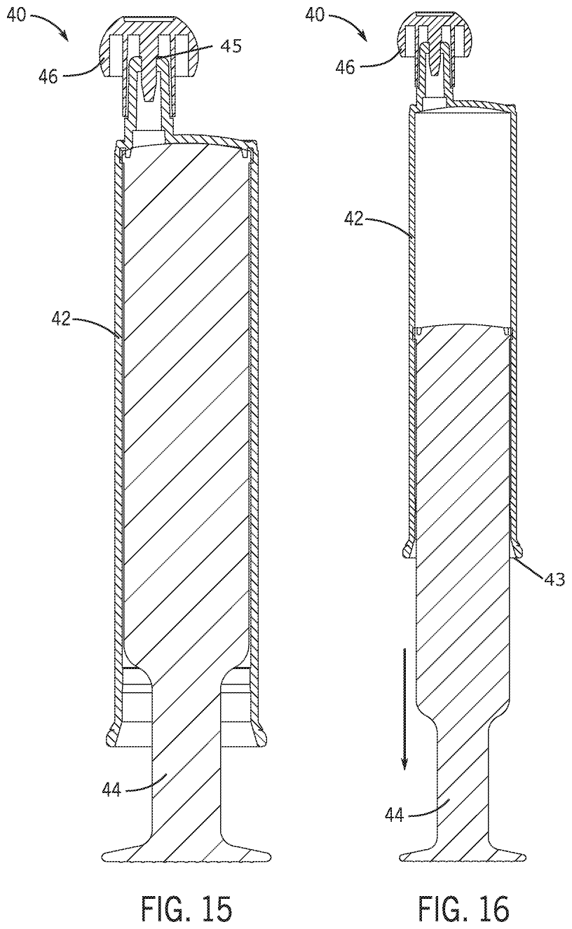

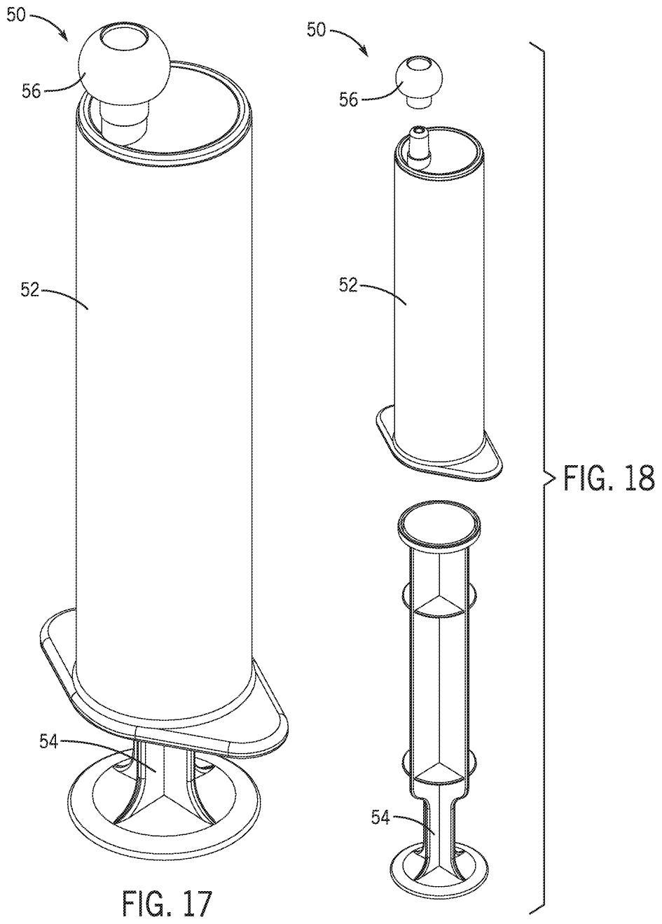

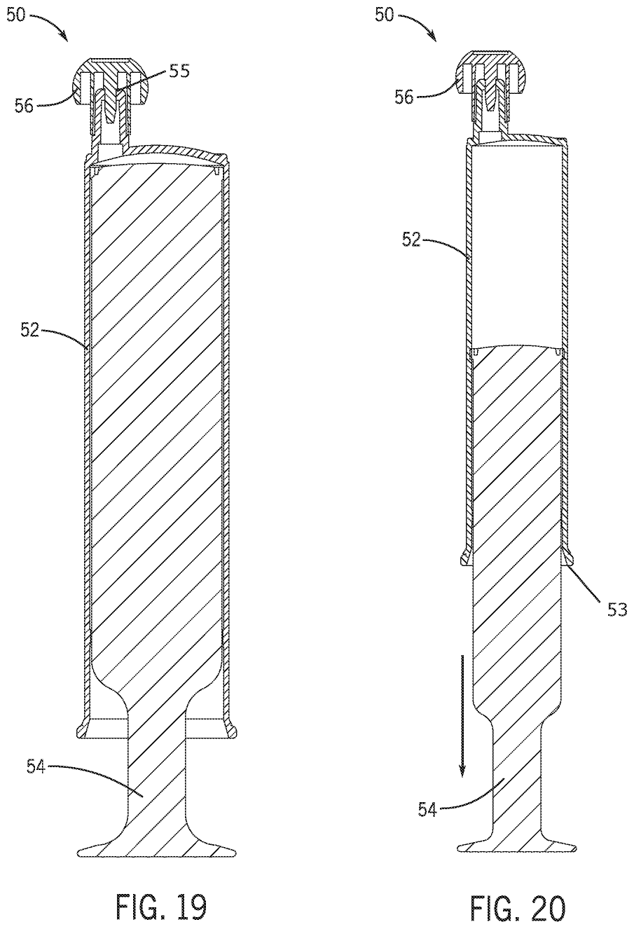

Referring now to FIGS. 1 through 20, the present invention may include a liquid medicament dispenser 10, 20, 30, 40, or 50 having a tubular barrel, 12, 22, 32, 42 or 52, respectfully, extending from a plunger end 13, 23, 33, 43 or 53 to a cap end 15, 25, 35, 45 or 55, and without a washer. The present invention may include a plunger 14, 24, 34, 44, or 54 dimensioned and adapted to hermetically engage the inner circumference of the tubular barrel, 12, 22, 32, 42 or 52, so that as it moves between a fully compacted condition (see FIGS. 3, 7, 11, 15, 19) and a partially compacted condition (see FIGS. 4, 8, 12, 16, 20) pressure develops in the tubular barrel, 12, 22, 32, 42 or 52, thereby urging a liquid (not shown) therein through the cap end 15, 25, 35, 45 or 55, and similarly urging the same liquid out of the cap end 15, 25, 35, 45 or 55 when the plunger 14, 24, 34, 44, or 54 is moved toward the fully compact condition. The liquid medicament dispenser 10, 20, 30, 40, or 50 may provide a plurality of embodiments, each having different volumetric capacities of their respective tubular barrel, 12, 22, 32, 42 or 52; for example, the liquid medicament dispenser 10 may be associated with a 1 mL volumetric capacity; the liquid medicament dispenser 20 may be associated with a 3 mL volumetric capacity, the liquid medicament dispenser 30 may be associated with a 5 mL volumetric capacity, the liquid medicament dispenser 40 may be associated with a 10 mL volumetric capacity, and the liquid medicament dispenser 50 may be associated with a 20 mL volumetric capacity. The present invention may include a cap 16, 26, 36, 46, or 56, respectively, dimensioned and adapted to removably seal any of the respective cap ends 15, 25, 35, 45, or 55, each having a cap opening, as illustrated in the Figures, whereby the present invention can be positioned in a sealed (with cap 16, 26, 36, 46, or 56 engaging the cap opening) and an unsealed configuration.

A method of using the present invention may include the following. The liquid medicament dispenser 10, 20, 30, 40, or 50 disclosed above may be provided. By moving the respective plunger 14, 24, 34, 44, or 54 from the fully compacted to the partially compacted condition, when the present invention is positioned in the unsealed configuration, a liquid medicament may be selectively drawn into the respective tubular barrel, 12, 22, 32, 42 or 52 through the respective cap end 15, 25, 35, 45, or 55 for subsequent dispensing through the same by moving the respective plunger 14, 24, 34, 44, or 54 back toward the fully compacted condition. Prior to dispensing or storage, the present invention can be positioned in the sealed configuration.

It should be understood, of course, that the foregoing relates to exemplary embodiments of the invention and that modifications may be made without departing from the spirit and scope of the invention as set forth in the following claims.

What is claimed is:

1. A liquid medicament dispenser without a washer, comprising:
a tubular barrel extending from a plunger end to a cap end having a cap opening; and
a plunger dimensioned to hermetically engage an inner circumference of the tubular barrel so that as the plunger moves between a compacted condition and a partially compacted condition pressure develops therein, thereby urging a flow out through the tubular barrel.

2. The liquid medicament dispenser without a washer of claim 1, further comprising:
a cap dimensioned to engage the cap end in a sealed configuration, preventing said flow; and the cap being movable between the sealed configuration and an unsealed configuration.

3. The liquid medicament dispenser without a washer of claim 1, further comprising:
the cap end is asymmetrically disposed along the cap end.

4. The liquid medicament dispenser without a washer of claim 1, wherein the tubular barrel defines a volumetric capacity ranging between one and ten milliliters.

5. A liquid medicament dispenser without a washer, comprising:
a tubular barrel extending from a plunger end to a cap end having a cap opening;
a plunger dimensioned to hermetically engage an inner circumference of the tubular barrel so that as the plunger moves between a compacted condition and a partially compacted condition pressure develops therein, thereby urging a flow out through the tubular barrel;
a cap dimensioned to engage the cap end in a sealed configuration, preventing said flow; and the cap being movable between the sealed configuration and an unsealed configuration; and
the cap end is asymmetrically disposed along the cap end, wherein the tubular barrel defines a volumetric capacity ranging between one and ten milliliters.

6. A two-piece liquid medicament dispenser, comprising:
a tubular barrel extending from a plunger end to a cap end having a cap opening; and
a plunger dimensioned to hermetically engage an inner circumference of the tubular barrel so that as the plunger moves between a compacted condition and a partially compacted condition pressure develops therein, thereby urging a flow out through the tubular barrel.

7. The two-piece liquid medicament dispenser of claim 6, further comprising:
a cap dimensioned to engage the cap end in a sealed configuration, preventing said flow; and the cap being movable between the sealed configuration and an unsealed configuration.

8. The two-piece liquid medicament dispenser of claim 6, further comprising:
the cap end is asymmetrically disposed along the cap end.

9. The two-piece liquid medicament dispenser of claim 6, wherein the tubular barrel defines a volumetric capacity ranging between one and ten milliliters.

10. The two-piece liquid medicament dispenser of claim 6, further comprising:
a cap dimensioned to engage the cap end in a sealed configuration, preventing said flow; and the cap being movable between the sealed configuration and an unsealed configuration; and
the cap end is asymmetrically disposed along the cap end, wherein the tubular barrel defines a volumetric capacity ranging between one and ten milliliters.
